(19) United States
(12) Patent Application Publication
(10) Pub. No.: US 2024/0381448 A1
(43) Pub. Date: Nov. 14, 2024

(54) MINI SLOTTED RANDOM ACCESS PROTOCOL WITH AN AGE THRESHOLD

(71) Applicant: ORTA DOGU TEKNIK UNIVERSITESI, Ankara (TR)

(72) Inventors: Mutlu AHMETOGLU, Ankara (TR); Orhan Tahir YAVASCAN, Ankara (TR); Elif UYSAL, Ankara (TR)

(73) Assignee: ORTA DOGU TEKNIK UNIVERSITESI, Ankara (TR)

(21) Appl. No.: 18/684,694

(22) PCT Filed: Aug. 16, 2022
(86) PCT No.: PCT/TR2022/050864

§ 371 Date: Feb. 19, 2024

(30) Foreign Application Priority Data
Aug. 17, 2021 (TR) 2021/013006

(51) Int. Cl. H04W 74/0833

(52) U.S. Cl. CPC H04W 74/085

(57) ABSTRACT

A mini slotted random access protocol with an age threshold is used only by terminals that exceed the threshold value in terms of age of information, and has different probabilities of transmission in each mini slot in the protocol, the user population is shaped such that the age of information is minimized.

### CROSS REFERENCE TO THE RELATED APPLICATIONS

This application is the national phase entry of International Application No. PCT/TR2022/050864, filed on Aug. 16, 2022, which is based upon and claims priority to Turkish Patent Application No. 2021/013006, filed on Aug. 17, 2021, the entire contents of which are incorporated herein by reference.

### TECHNICAL FIELD

The invention relates to a novel link layer protocol.

### BACKGROUND

Many protocols have been developed for different requirements in the MAC (Medium Access) sublayer of the Link layer for wireless networks in the state of the art so far. These protocols can be categorized into three main branches according to channel access methods; multiplexing, scheduling, or random access. The first category envisages the use of the channel by sharing between users based on time or frequency. The channel access authorization and command are managed by the main access point in the centralized protocols. In the random access protocols, users decide to access the channel by themselves without a direct command from the access point and act randomly to prevent packet collisions. Of the random access methods, the most important ones are as follows:
ALOHA (Slotted ALOHA)
CSMA (Carrier Sense Multiple Access) (CSMA/CA (collision avoidance), CSMA/CD (collision detection) (For example, IEEE 802.11, Ethernet)

There are already hundreds of protocols developed based on the above methods, but a substantial amount of these protocols have been developed with the channel throughput as the main metric. Today, with the internet of things (IoT) and machine type communications (MTC) becoming popular, it has become clear that the throughput is not an adequate metric per se. In such networks, the timely transmission of information in small packets is fundamental, and as the main criterion, the age of the last sent packets must be used instead of the channel efficiency. Accordingly, analysis of existing protocols has indicated that these protocols showed a performance far from optimal values.

It is seen in said patent documents that mini slots are used for control purposes in the frame structure. However, other than this patent, there are different studies in which mini slots are used, in the literature. That is to say, the concept of mini slots for control purposes is not new. In patent document No. U.S. Pat. No. 6,493,334, each mini slot is associated with a single user and mini slots are used to analyze the user who sent the information. In the protocol, a structure similar to ALOHA is followed, but contrary to ALOHA, the packets that are sent simultaneously may not result in collisions.

It should also be noted that the ALOHA protocol is commonly used and even considered as a benchmark in random access channels. Its main purpose is to maximize the data rate by reducing collisions in a distributed and simplistic way. However, the Age of Information metric has gained importance to become as useful as the data rate for the machine type communications in recent years. The ALOHA protocol is not a protocol that is optimized for this metric. It is evaluated under the same class with various ALOHA based protocols in terms of the basic method.

Another document closely related is titled Age of Information in Random Access Networks with Stochastic Arrivals. The age of information is a concept that was suggested in the 2010s to measure and study the value and importance of packets in terms of time in communication networks. In the paper to Kadota et al., the age of information in random access channels was analyzed and methods optimization thereof were obtained. The time dimension is completely divided into slots called mini slots, and a protocol similar to slotted ALOHA is analyzed. However, the channel access probability can not be changed according to the age of information in the protocol analyzed. It is not possible to influence transmission times based on the age of information. Consequently, it does not provide a high-level performance increase. The reason why the slots are called mini slots in the paper to Kadota et al. is that the data packets are large enough to cover more than one mini slot. The slots are large enough to complete a packet transfer in the slotted ALOHA. Sending packets in multiple slots instead of being sent in a single slot presents a fundamental difference between said protocols. Also, a structure similar to the age threshold is not present herein.

### SUMMARY

The invention relates to a novel link layer protocol that we call mini slotted random access protocol with an age threshold to eliminate the above-mentioned disadvantages and bring new advantages to the related technical field.

The protocol according to the invention is a novel ALOHA based protocol that optimizes the age of information.

The protocol developed with the invention has been developed for the medium access (MAC) sublayer in the link layers according to the OSI model in communication networks. The primary purpose of the protocol is the optimization of the age of information by maintaining the random access structure.

The main purpose of the protocol is to minimize the age of information metric, which has great importance in applications such as mMTC (massive machine type communication) and IoT (internet of things). The difference between these applications and conventional networks is that a large number of devices must be in constant communication in numerous environments. Autonomous vehicles can be an example of this. For autonomous vehicles, time-critical information should reach its destination without delay, both within the vehicle and between different vehicles. In such applications, rather than the data rate, the delay times in transmitting the packets will have importance. The protocol has been developed to satisfy the need for small age of information in such applications.

The novelty provided by the invention is that the mini slots:
(1) Are used only by terminals that exceed the threshold value in terms of age of information,
(2) Have different probabilities of transmission in each mini slot in the protocol, the user population is shaped such that the age of information is minimized.

With this protocol, a symmetrical hierarchy among users is maintained and mini slots are not reserved for any user. All users are free to use any mini slot as long as it is permitted by the protocol rules. Further, the conventional slotted ALOHA structure is maintained in the data slots as well. Additionally, the mini slot structure has been used in an innovative way for the age of information optimization.

It is also possible to change the channel access probability according to the age of information and to decide to transmit according to the age of information in the protocol analyzed in the invention.

Accordingly, the inefficiency of equivalent technologies has been detected, and it is aimed with the protocol to eliminate these drawbacks by using the novelties described above. The performance of the protocol in terms of age of information and channel efficiency is compared with other methods in Table 1. It is considered that the lengths of the mini slots are very small in comparison with the data slot, and their effects are ignored. The age of information comes close to the theoretical limit by 6% in the use of 32 mini slots. The simplicity of the protocol on the user side carries the protocol in the invention one step further.

TABLE 1
Comparison of average age values and channel efficiencies
of equivalent protocols (Δ: Average Age of Information,
n: Number of Users, T: Channel efficiency)

| | Δ/n | T |
|---|---|---|
| Slotted ALOHA | e ≈ 2.71 | e⁻¹ ≈ 0.3678 |
| Threshold ALOHA | 1.41 | 0.364 |
| Reservation Based | 1.01 | 0.99 |
| Random Access (32 | | |
| Mini Slots) | | |
| INVENTION (32 Mini | 0.53 | 0.95 |
| Slots) | | |
| Theoretical Limit | 0.5 | 1 |

The invention is an application to improve the age of information performance of the mini slot structure. The age threshold mechanism suggested in the protocol provides the improvement required for the age of information and reduces the average age of information by almost half compared to the protocols using the mini slot structure in the literature. The problem of the existing protocols as described above can be summarized as that they are not designed according to the age of information, and thus the channel control mechanism ignores the age of information.

With the invention, it is critical that the protocol developed performs better than its equivalents in terms of the age of information. Improvements made accordingly are as follows:
1. Using the age threshold
2. Using multiple mini slots for access control purposes
3. Protocol parameters optimized based on the age of information

The age threshold prevents users who have recently transmitted a packet and have smaller age of information compared to other users from accessing the channel. Thereby, the system parameters can be adjusted such that the probability of successful transmission of users with bigger age of information is increased. The age threshold used in the protocol differentiates between these two groups, and ideal results are obtained when it is optimized jointly with the transmission probability parameters in the mini slots. Another improvement is the mini slots used to control the channel access. What is aimed at with the use of mini slots is improving the low channel efficiency in protocols similar to ALOHA. Users are given the chance to use or not use the channel more than once, and the probability of the channel being idle without any packet transmission in a slot is reduced. The mini slot concept is a solution, which has not yet been used among the protocols developed based on the age of information, thus being an innovative solution for existing problems. Users active in mini slots send a packet indicating that they want to use the channel with a certain probability, as in ALOHA. What is aimed at with that is maintaining the simplicity on the user side, as in ALOHA. Another novelty is that the parameters can be calculated according to the age of information and with low complexity.

### BRIEF DESCRIPTION OF THE DRAWINGS

The drawings and related explanations used to explain the protocol developed with this invention better are given below.

FIG. 1 illustrates a system model consisting of N user and access point.

FIG. 2 illustrates an age threshold mechanism.

FIG. 3 illustrates a structure of slots.

FIG. 4 illustrates a flowchart of the protocol on the user side.

FIG. 5 illustrates a Simulation Comparison Graph (average age of information-packet size (L)).

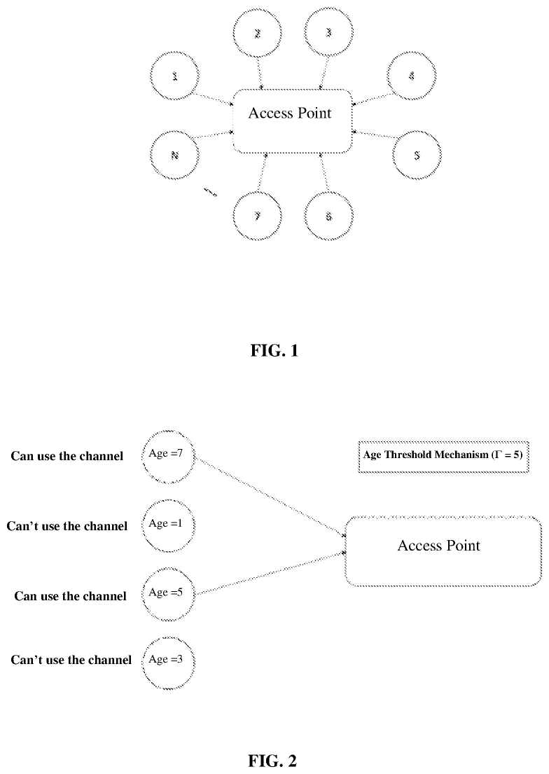

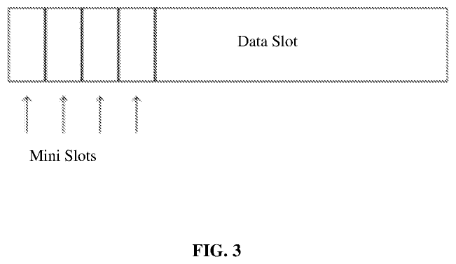

### DETAILED DESCRIPTION OF THE EMBODIMENTS

In this detailed description, the novelty of the invention is only explained by way of examples that will not have any limiting effect on understanding the subject matter better.

The said invention relates to a novel link layer protocol named multi-mini slotted threshold ALOHA. In other words, it is related to a mini slotted random access protocol with an age threshold.

It is based on slotted ALOHA, which has been used in computer networks for many years. The novelty provided by the protocol is the addition of age of information control threshold mechanism to the slotted ALOHA protocol. Thereby, the protocol speeds up at a rate up to 53 percent, and the age of information obtained reduces to about one-third. Namely, it provides both faster and fresher data transmission. Therefore, the invention provides a considerable performance increase for machine type communication systems, particularly satellite IoT systems.

Slotted ALOHA is a simple algorithm used to access the channel at the link layer of networks. However, there are various applications where slotted ALOHA is insufficient; in slotted ALOHA, channel efficiency can only rise to 37%, and the constant symmetry among users, in some cases, leads to suboptimal performance.

By failing to satisfy the need for timely information arrival to the required point noticed by numerous technological applications (IoT) gaining popularity day by day, a search for new protocols has started in the scientific community, and a new metric called the Age of Information has been formed to quantitatively measure the timely information arrival. The metric, age of information, is defined for each user and represents the age of the last packet successfully transmitted by a user, that is, the time elapsed between now and when the packet was generated. The average age of information is the arithmetic mean of all users' ages.

The system model in the invention consists of a single access point that collects information from n users and provides services. Communication between users and the access point is performed in slotted time intervals, and a successful information transfer from a user to the access point is carried out only if no other user tries to use the channel in the slot when the transmission is made. Packets are not very large and can be transmitted within a single slot. In the protocol developed, it is essential to minimize the age of information, and it is aimed that users can make independent decisions by using this metric. The users who will send data create their packets just before initiating the communication for the age of information to be as small as possible. For users to be able to update the age of information metric, the access point provides a successful packet transfer feedback to the user who sent the packet.

The first novelty provided in the protocol in the invention is the presence of a threshold age value envisaged for users to use the channel. The age threshold is denoted by Γ. Sources that are not older than Γ remain inactive until their age reaches the threshold value, thereby the number of sources with which sources with an older age of information have to compete, thus increasing their successful transfer probability. So, the probability of resetting the age of information of the sources with a bigger age of information increases, which reduces the average age of information. Only with this addition, when its parameters are set correctly, it can reduce the age of information to 1.41n. To clarify the modification made in the timing structure as well as this threshold value mechanism, slots are homogeneous blocks in standard slotted ALOHA, and they span a sufficient amount of time for a source to transfer its unit information.

As for the new algorithm, slots consist of two main parts, namely mini slots, and data slots. Mini slots are smaller than the data slots, and data slots have been developed to be used by only one user. There are W mini slots in total, τ represents the mini slot, and mini slots τ0, τ1, . . . , τW−1 indicate the probabilities of sending an RTS message expressing users' intention to send a packet in the data slot. Users decide whether to send a message or not by carrying out Bernoulli trials based on these probabilities. What is meant by carrying out the Bernoulli trial with the probability t is comparing a randomly generated number in the range of 0 and 1 with t. The protocol developed applies to different W values, and in case W is 0, only the data slot remains. The described protocol applies to positive W numbers. The main parameters of the protocol are W, τ0, τ1, . . . , τW−1, and Γ, and are determined according to the requirements of the system they are contained. The main parameter values recommended according to a predetermined W value are as follows (The formulas expressed herein are the parameter values that can be used to achieve near-optimal results. The said parameters are transmission probabilities that are also expressed in the flow, and used in the Bernoulli trials (iv. and x. in the method)):

The series B₀, B₁, B₂ . . . is defined as follows:

$${B}_{0} = 1$$

$${B}_{k} = 1 - exp ( - {B}_{k - 1} )$$

Then τ₀, τ₁, . . . , τ_{W-1} can be selected as follows to achieve optimal results in terms of flow rate, and near-optimal results in terms of age of information:

$${τ}_{j} = \frac{\text{?}}{\text{?}} j = 0 , 1 , … , W - 1$$

$$\text{?} \text{indicates text missing or illegible when filed}$$

τ and τ₀ are also set to optimize the age of information according to the number of users.

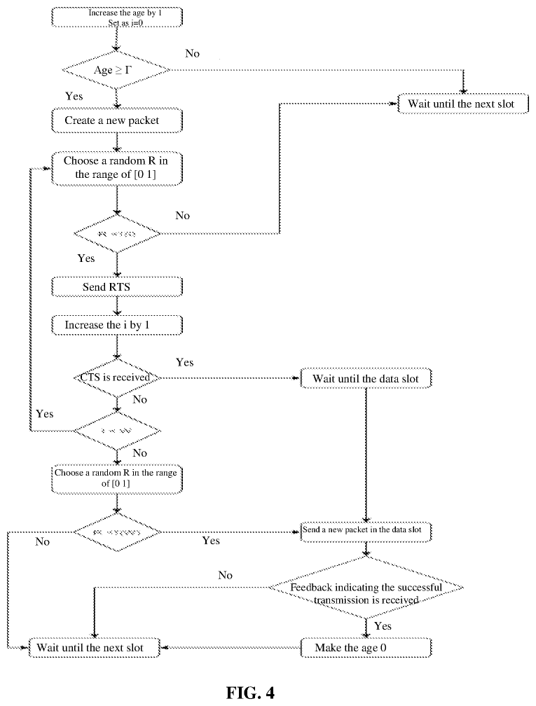

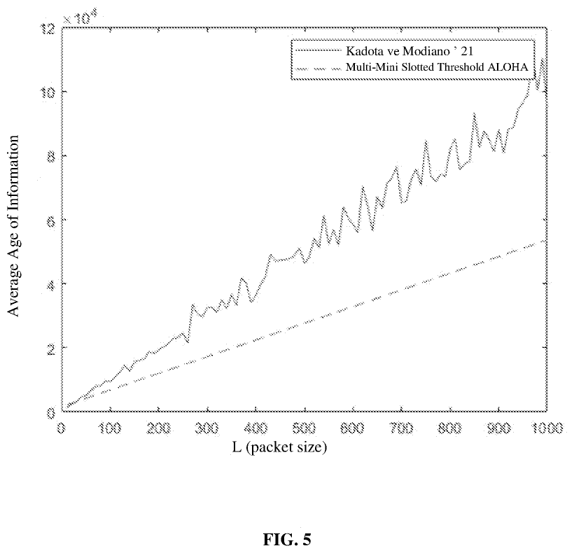

A slot flow is as follows (the flowchart is given in FIG. 4):

Said invention is the operation method of a novel link protocol (mini slotted random access protocol with an age threshold), characterized in that it comprises the following steps
i. Updating, by the users, their age of information, and controlling whether their age exceeds the age threshold (T) or not,
ii. If the age of the users is smaller than the age threshold (T), being inactive during the rest of the slot (the said slot is the current slot),
iii. If the age of the users reaches the age threshold (T), creating a new packet,
iv. Carrying out the Bernoulli trial with probability TO for users who are active in the first mini slot, and sending a packet (RTS) in the link layer indicating that they want to use the slot by the users whose Bernoulli trial is successful (condition of success; Bernoulli trial is successful with probability TO and fails with probability 1−τ0),
v. Abandoning the usage of this slot and the data slot in it, and waiting as inactive until the next slot by the users whose Bernoulli trial fails,
vi. Sending, by the access point, to that user feedback (CTS) indicating that it can use the slot if a packet (RTS packet) at the link layer is sent from a single user,
vii. Providing, by the access point, feedback to the users in the channel indicating whether multiple packets are sent from more than one user in this way,
viii. Then, carrying out another Bernoulli trial in the second mini slot for users who have not become inactive (The probability of success in this trial is τ1 since it is the second mini slot.),
ix. Repeating the flow as stated in the iv., and described in the first mini slot until not more than one user remains active in this mini slot and the subsequent mini slots, or until all mini slots have passed,
x. Carrying out the Bernoulli trial with probability TW to access the channel by users still active in the data slot (if any),
xi. At the end of the data slot, broadcasting, by the access point, feedback indicating whether it has been a successful packet transfer or not,
xii. Updating, by the users, their age of information accordingly, and passing to the next slot.

Channel efficiency is still an important performance parameter, despite the importance of the age of information. Although protocols such as ALOHA envisage that users make independent decisions, their efficiency remains at only 18%. Slotted ALOHA developed to reduce packet collisions increased the efficiency to 37%. Efficiency can be further increased by dividing the slots into smaller slots called mini slots.

The protocol in the invention as described above is also developed based on this improvement. The mini slot mechanism has been used in Q-CSMA (queue-length based CSMA) or reservation based random access protocols in random access protocols for different needs.

### Test and Simulations

The result of the simulations is shown in FIG. 4 to quantitatively express the improvements made in terms of performance for the performance comparison of the protocol in the said invention with the study titled Age of Information in Random Access Networks with Stochastic Arrivals in the state of the art. The simulations were carried out on models containing 100 users, and the figure above was obtained by compiling the results achieved as a result of 10\hat{ }6 slots. Expressed in this way, L represents the size of a packet in the time axis, that is, the number of mini slots required for sending. Mini slots can be as small as and even smaller than 10 μs, as stated in the paper to Kadota and Modiano, and this can result in a substantial amount of mini slots required to send packets. When packets are not ultra-small, the protocol in the invention provides an improvement of approximately 45% in the average age of information. As can be seen in FIG. 4, the improvements made in minimizing the mini slots also significantly increase the importance of the protocol in the invention compared to previous protocols.

1. An operation method of a mini slotted random access protocol with an age threshold, comprising:
i. updating, by the users, their age of information, and controlling whether their age exceeds the age threshold or not,
ii. if the age of the users is smaller than the age threshold, being inactive during the rest of slots,
iii. if the age of the users reaches the age threshold, creating a new packet,
iv. carrying out a Bernoulli trial with probability TO for users who are active in the first mini slot, and sending a packet in a link layer indicating that they want to use the slot by the users whose Bernoulli trial is successful with probability τ0,
v. abandoning usage of this slot and data slot in it, and waiting as inactive until the next slot by the users whose Bernoulli trial fails with probability 1−τ0,
vi. sending, by the access point, to that user feedback indicating that it can use the slot if a packet at the link layer is sent from a single user,
vii. providing, by the access point, feedback to the users in the channel indicating whether multiple packets are sent from more than one user in this way,
viii. carrying out another Bernoulli trial in the second mini slot for users who have not become inactive,
ix. repeating the flow as stated in the iv., and described in the first mini slot until not more than one user remains active in this mini slot and the subsequent mini slots, or until all mini slots have passed,
x. carrying out the Bernoulli trial with probability TW by the users if there are users still active in the data slot,
xi. at the end of the data slot, broadcasting, by the access point, feedback indicating whether it has been a successful packet transfer or not, and
xii. updating, by the users, their age of information accordingly, and passing to the next slot.
